(19) United States
(12) Patent Application Publication
(10) Pub. No.: US 2005/0219032 A1
(43) Pub. Date: Oct. 6, 2005

(54) METHOD AND APPARATUS FOR PROVIDING ELECTRICAL PROTECTION TO A PROTECTED CIRCUIT

(75) Inventors: Craig B. Williams, Avon, CT (US); Henry H. Mason JR., Plainville, CT (US); Michael S. Tignor, Watertown, CT (US); Geoffrey F. Butland, Farmington, CT (US); Michael Bradley, Jensen Beach, FL (US); Gregory P. Lavoie, Bristol, CT (US)

Correspondence Address: CANTOR COLBURN, LLP, 55 GRIFFIN ROAD SOUTH, BLOOMFIELD, CT, 06002, US

(73) Assignee: GENERAL ELECTRIC COMPANY, Schenectady, NY (US)

(21) Appl. No.: 10/708,933

(22) Filed: Apr. 1, 2004

(51) Int. Cl. H01H 37/02

(52) U.S. Cl. 337/3; 337/13

(57) ABSTRACT

An apparatus for providing electrical protection to a protected circuit in electrical communication with an electrical source is disclosed. The apparatus includes a housing, a separable conduction path in series connection with the protected circuit, an operating mechanism in operable communication with the separable conduction path, a thermal element in thermal communication with the separable conduction path, and an electronic trip unit in signal communication with the thermal element and in operable communication with the operating mechanism. The electronic trip unit is adapted to sense a voltage drop across the thermal element and to trip the operating mechanism in response to the sensed voltage drop being in excess of a first trip threshold.

### BACKGROUND OF INVENTION

The present disclosure relates generally to a method and apparatus for providing electrical protection to a protected circuit, and particularly to an electronic trip unit having a low cost current sensor.

Electrical circuit breakers may be connected between an electrical source and an electrical load to protect the load and connected wiring from overcurrent conditions that may fall within a long-time, short-time, or instantaneous band on a time-current characteristic curve. To provide such protection, various trip units may be employed, including thermal, magnetic, and electronic. Thermal and magnetic trip units have the advantage of being directly responsive to current flow, but involve a substantial degree of calibration at the site of manufacture. Electronic trip units have the advantage of being easily adjusted and configured to interface with electromechanical accessories, but are sensitive to the magnetic characteristics of the current transformers that provide power, and in some cases current sensing, to the electronics. Accordingly, there is a need in the art for an electrical circuit breaker arrangement, and specifically a trip system for an electrical circuit breaker arrangement, that overcomes these drawbacks.

### SUMMARY OF INVENTION

Embodiments of the invention disclose an apparatus for providing electrical protection to a protected circuit in electrical communication with an electrical source. The apparatus includes a housing, a separable conduction path in series connection with the protected circuit, an operating mechanism in operable communication with the separable conduction path, a thermal element in thermal communication with the separable conduction path, and an electronic trip unit in signal communication with the thermal element and in operable communication with the operating mechanism. The electronic trip unit is adapted to sense a voltage drop across the thermal element and to trip the operating mechanism in response to the sensed voltage drop being in excess of a first trip threshold.

Additional embodiments of the invention disclose a method of protecting an electrical circuit in electrical communication with an electrical source. The voltage drop across a resistive element disposed in a separable conduction path is sensed, where the conduction path is connected in series with the electrical circuit. In response to the sensed voltage drop, a value representative of the current in the conduction path is calculated, and the calculated value is compared to a threshold value. In response to the calculated value being in excess of the threshold value, an operating mechanism is tripped and the separable conduction path is separated.

### BRIEF DESCRIPTION OF DRAWINGS

Referring to the exemplary drawings wherein like elements are numbered alike in the accompanying Figures:

FIG. 1 depicts an exemplary apparatus in accordance with embodiments of the invention;

FIG. 2 depicts exemplary characteristic curves for practicing embodiments of the invention; and

FIG. 3 depicts an exemplary method diagram for practicing embodiments of the invention.

### DETAILED DESCRIPTION

An embodiment of the invention provides an apparatus equipped with a thermal element and an electronic trip unit, wherein the electronic trip unit senses a voltage drop across the thermal element, compares the voltage drop to a defined threshold, and trips the circuit breaker in response to the defined threshold being exceeded. In an embodiment, the apparatus may be a circuit breaker and the thermal element may be a bimetal. While embodiments described herein may depict a bimetal as an exemplary thermal element, it will be appreciated that the disclosed invention may also be applicable to other thermal elements, such as shape memory alloy for example. While embodiments described herein may depict a double break rotary circuit breaker as an exemplary protection apparatus, it will be appreciated that the disclosed invention may also be applicable to other protection apparatuses, such as a single break circuit breaker or a smart (electronic) switch for example. While embodiments described herein may depict only one pole or phase of a circuit breaker, it will be appreciated that the disclosed invention may also be applicable to an electrical system having multiple poles or phases.

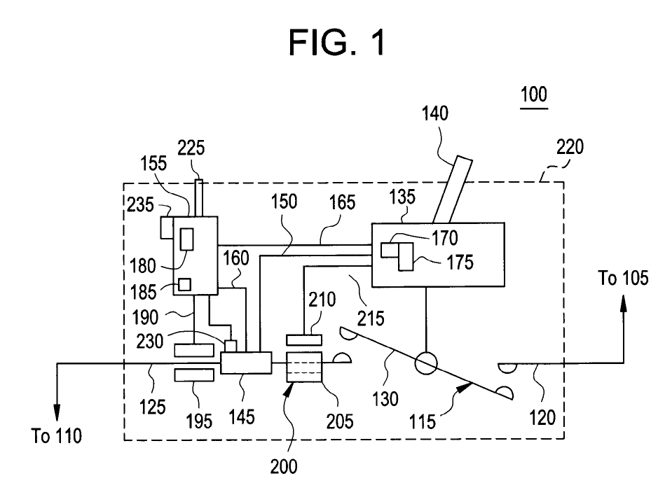

FIG. 1 is an exemplary embodiment of a circuit breaker 100, in electrical communication with an electrical source 105, which provides electrical protection to a protected circuit 110. In an embodiment, a separable conduction path 115 includes a line conductor 120, a load conductor 125, and a rotary contact arm 130. An operating mechanism 135 having a handle 140 is in operable communication with contact arm 130 for opening and closing the separable conduction path 115. In a closed and operable condition, current passes from source 105 to circuit 110 through circuit breaker 100 via line conductor 120, contact arm 130, and load conductor 125.

A thermal element 145 is in thermal communication with separable conduction path 115 such that a resultant temperature at, and voltage drop across, thermal element 145 is representative of a current level within separable conduction path 115. In an embodiment, thermal element 145 is a resistive element and is electrically connected in series with separable conduction path 115, thereby resulting in a voltage drop across thermal element 145 as a function of the current within separable conduction path 115. Embodiments of the invention may employ a bimetal for thermal element 145, which may also be used to mechanically trip operating mechanism 135 at defined current thresholds via signal line 150, which is representative of trip arms, trip bars and trip latches. Alternative embodiments of the invention may employ a shape memory alloy for thermal element 145 that may also trip operating mechanism 135 at defined current thresholds. Yet further embodiments of the invention may employ only a resistive element for thermal element 145 to provide a voltage drop in the absence of an associated mechanical trip action.

An electronic trip unit 155 is in signal communication with thermal element 145 via signal line 160, and in operable communication with operating mechanism 135 via signal line 165. In an embodiment, signal line 160 is a voltage lead that communicates the voltage drop across thermal element 145 to electronic trip unit 155, and signal line 165 is a low voltage power line to a flux shifter 170 for releasing a latch mechanism 175 to trip operating mechanism 135. Electronic trip unit 155 includes a processing circuit 180 for processing the signals received from thermal element 145, the signals being representative of the voltage drop across thermal element 145, comparing the sensed voltage drop to a trip threshold stored in a memory 185, and initiating a trip signal to be sent on signal line 165 to operating mechanism 135.

In signal communication with electronic trip unit 155 via signal line 190 is a current transformer 195 that provides power to electronic trip unit 155, thereby utilizing the line voltage of power source 105 to power-up the electronics. In an embodiment, current transformer 195 is a toroidal current transformer that surrounds load conductor 125. Current transformer 195 may be a power current transformer only, or may be a combination of power current transformer and a signal current transformer. As used herein, a power current transformer is a current transformer that employs sufficient ampere-turns for providing power to electronic trip unit 155, but insufficient ampere-turns for providing a signal accurately representative of the current in load conductor 125, and a combination power/signal current transformer is a current transformer that is a power current transformer that also employs sufficient ampere-turns for providing a signal accurately representative of the current in load conductor 125. In an embodiment where current transformer 195 is a power current transformer only, the voltage drop across thermal element 145 serves to provide electronic trip unit 155 with a signal accurately representative of the current in load conductor 125.

In an embodiment, circuit breaker 100 also includes a magnetic trip unit 200 having a magnetic yoke 205 that partially surrounds load conductor 125, and a magnetic armature 210 that is magnetically coupled to magnetic yoke 205. Armature 210 is biased away from yoke 205 under non-short circuit current conditions, and is magnetically attracted to pole faces of yoke 205 at a defined short circuit level of current that passes through load conductor 125. Armature 210 is in operable communication with operating mechanism 135 via signal line 215, which may be arranged in a manner similar to signal line 150, that is, using trip arms, trip bars and trip latches. In this manner, magnetic trip unit 200 is in signal communication with separable conduction path 115, and in operable communication with operating mechanism 135. Upon the occurrence of a short circuit current that exceeds a defined threshold, armature 210 of magnetic trip unit 200 will respond to mechanically trip operating mechanism 135 independent of electronic trip unit 155.

Alternative embodiments may employ a resistive element or a bimetal element for thermal element 145. In an embodiment utilizing either a resistive element or a bimetal element, thermal element 145 is configured to provide a voltage signal accurately representative of the current in load conductor 125. However, in an embodiment utilizing a bimetal element, thermal element 145 may be configured to also deflect in response to resistive heating, and to trip operating mechanism 135 via signal line 150 at a defined or calibrated current level that is in excess of a trip threshold.

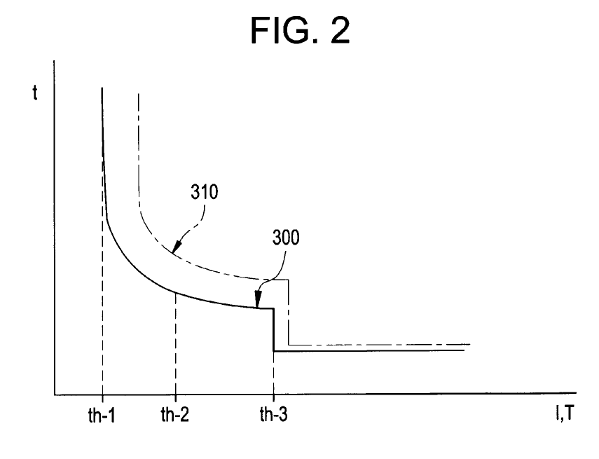

Referring now to FIG. 2, an exemplary time-current curve 300 is depicted, where time “t” is along the ordinate, and current “I” is along the abscissa. Long-time, short-time, and instantaneous time-current curve regions are depicted, which will be discussed in more detail later. Alternatively, curve 300 may also be representative of an exemplary time-temperature curve, where temperature “T” is along the abscissa. The relationship between time, current and temperature may be defined by an I-squared-t (ampere-squared-seconds) equation, or an I-squared-R-t (ampere-squared-ohm-seconds) equation, such as:
T=f(I²dt), or
T=f(I²Rdt),
where the function “f” is an integral function, and R is the resistance of thermal element 145.

In an embodiment where a temperature coefficient of resistance characteristic of thermal element 145 is utilized by processing circuit 180, resistance R may be defined as:
R=R0[1+a(T−T0)],
where R0 is a baseline resistance at a baseline temperature T0, T is the temperature of thermal element 145, a is the temperature coefficient of resistance of thermal element 145, and R is the resistance of thermal element 145 at temperature T. Temperature T may be determined by employing a temperature sensor 230 disposed at thermal element 145, or by performing iterative I2dt finite difference calculations at processing circuit 180.

Processing circuit 180 may then calculate the current I in load conductor 125 by utilizing the equation:
I=E/R,
where E is the voltage drop across thermal element 145 as seen and communicated via signal line 160.

As seen by reference to FIG. 2, a first trip threshold th-1, a second trip threshold th-2, and a third trip threshold th-3, which are representative of defined trip threshold current levels, are depicted along the abscissa. In response to the current I in load conductor 125 being greater than threshold th-1 and less than threshold th-3 (within the long-time and short-time regions), and the time duration of current I being greater than that defined by curve 300 (that is, above the curve), electronic trip unit 155, via the programming of processing circuit 180, will trip operating mechanism 135 to open separable conduction path 115. Characteristic curve 300 may be stored in memory 185 or in an alternative memory at processing circuit 180. In response to the current I being greater than threshold th-3 (within the instantaneous region), either magnetic trip unit 200 or thermal element 145 may be configured to trip operating mechanism 135. In response to the current I being greater than threshold th-2 and less than threshold th-3 (within the short-time region), either electronic trip unit 155 or thermal element 145 may be configured to trip operating mechanism 135. In an embodiment, circuit breaker 100 is configured such that electronic trip unit 155 trips operating mechanism 135 in response to the sensed voltage drop across thermal element 145 being representative of a current level in load conductor 125 being in excess of first trip threshold th-1 or second trip threshold th-2, and either or both magnetic trip unit 200 and thermal element 145 trips operating mechanism 135 in response to the current in load conductor 125 being in excess of third trip threshold th-3. In this manner, where the power-up of current transformer 195 may not be timely responsive to a first half-cycle short circuit current, due to hysteresis magnetization effects, either magnetic trip unit 200 or thermal element 145 will be timely responsive, thereby limiting I2t heating effects in the protected circuit 110 and connected wiring under short circuit conditions. In an embodiment, a user, by interfacing with adjustment button 225, may adjust one or more of the trip thresholds subsequent to circuit breaker 100 being installed in the field in an application. Adjustment button 225 may be configured to adjust a mechanical interface, such as a change in an air gap or a bias force at thermal element 145 or magnetic trip unit 200, or an electronic interface, such as a change in a burden resistor value at electronic trip unit 155, depending on the desired features to be installed in circuit breaker 100 and made available to the end user.

Circuit breaker 100 may be designed to have a one-size housing 220 suitable for providing multiple frame ratings, with the internal conductors being sized appropriately for the maximum current rating of the respective frame rating. As used herein, the term frame rating is intended to mean a maximum steady state ampere rating for which the internal conductors are suitably sized, and for which the trip units are responsively calibrated to. The steady state ampere rating within a frame is also referred to as an X-rating. For example, a circuit breaker frame may have a maximum frame rating of 150 amps, but may also have separate frame breaks, or frame ratings, at 15 amps, 30 amps, 60 amps, and 100 amps. Each frame break will have internal components sized appropriately for carrying the maximum current rating of that frame break, but may also be capable of being calibrated to have an X-rating that is lower than the maximum current rating of that frame break. For example, a 100 amp frame break may be calibrated to have a 70 amp, 80 amp, and 90 amp X-rating. In contrast to conventional bimetallic circuit breakers, where each X-rating typically, but with some exceptions, carries its own unique bimetal design, which requires multiple bimetal designs for the range of currents within a given frame break, embodiments of the invention may utilize a single bimetal over multiple frame breaks. For example, thermal element 145, herein also referred to as a bimetal element 145, may be sized to carry a first steady state electrical current, such as 15 amps, a second steady state electrical current, such as 30 amps, a third steady state electrical current, such as 45 amps, and a fourth steady state electrical current, such as 60 amps. With such an arrangement, electronic trip unit 155 may be configured to provide circuit breaker 100 with an X-rating of 15 amps, 30 amps, 45 amps, 60 amps, or any amperage in between, using a single bimetal to provide a voltage signal to electronic trip unit 155. In such an arrangement, electronic trip unit 155 would be calibrated to recognize how the voltage drop across bimetal element 145 correlates to the actual current in load conductor 125 depending on the X-rating of the device.

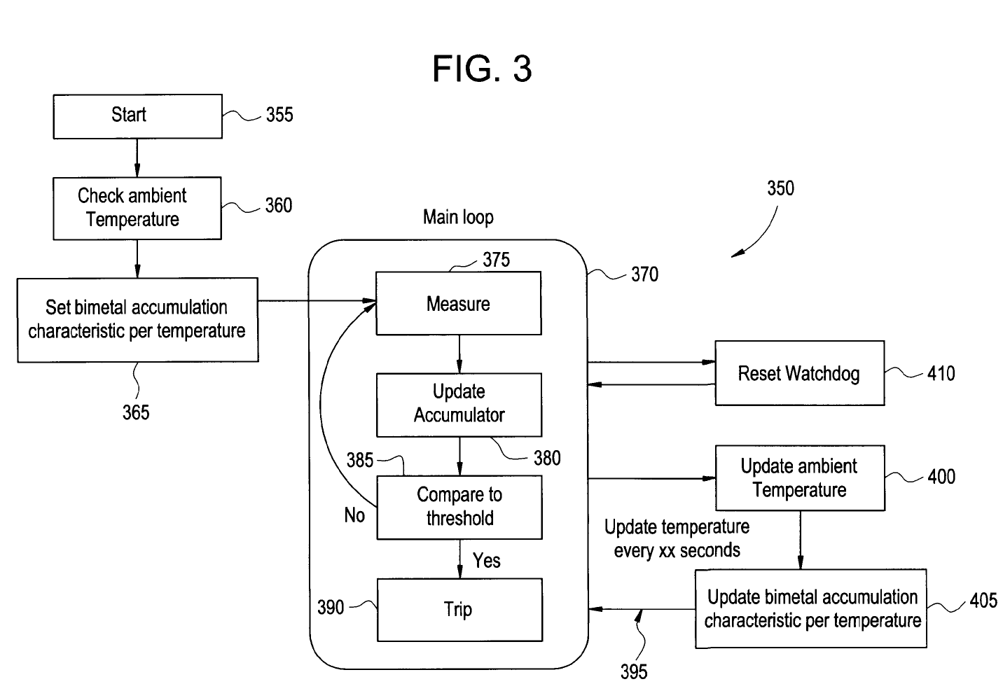

The manner in which processing circuit 180 analyzes a trip condition will now be discussed with reference to Figure 3, which depicts a method 350, performed by processing circuit 180, of protecting an electrical circuit, such as protected circuit 110, in electrical communication with electrical source 105. At the start 355 of method 350, the ambient temperature is checked since the ambient temperature may effect, via the temperature coefficient of resistance of thermal element 145, the voltage drop across thermal element 145. An ambient temperature sensor 235 may be arranged in any convenient location for determining the effective ambient temperature influencing the temperature rise of thermal element 145, which provides a representative signal that is communicated to processing circuit 180. At block 365, a processing circuit accumulator holding the bimetal (thermal element) accumulation characteristic is set according to the ambient temperature. As used herein, the term bimetal accumulation characteristic refers to a process of integrating current I over time t, and the mapping of the integration analysis with respect to the time-current curve 300 depicted in FIG. 2. In the main processing loop 370, the voltage drop across thermal element 145 is measured 375, the accumulator holding the bimetal accumulation characteristic is updated 380, and the resulting accumulator value is compared to the time-current curve 300 to determine if a threshold trip level has been reached or exceeded 385. If a trip threshold has not been reached, then the logic loops back to block 375. If a trip threshold has been reached, then a trip command is initiated 390 resulting in the tripping of operating mechanism 135. A secondary loop 395 that runs at a defined time interval is used to update the reading of the ambient temperature 400, and to update the bimetal accumulation characteristic as a function of the ambient temperature 405. In this manner, the analysis of main loop 370 is continually modified to reflect the actual current passing through thermal element 145. A reset watchdog function 410 enables all accumulators of processing circuit 180 to be reset on command. Such a reset function may be enacted in response to the tripping of circuit breaker 100. However, with temperature sensor 230 sensing the actual temperature of thermal element 145, a thermal memory of the protected circuit is maintained, thereby providing a degree of protection from overheating in the protected circuit and connected wiring in the event of a recently tripped circuit breaker 100.

As described, it will be appreciated that the voltage drop across thermal element 145, and hence the value calculated by processing circuit 180 that is representative of the current in separable conduction path 125, may be a function of the ambient temperature, the heat generated by the combination of current and time in thermal element 145, and the heat transferred into thermal element 145 from the conduction path including load strap 125. Accordingly and by appropriate programming, processing circuit 180 may be adapted to compensate for that portion of the sensed voltage drop across thermal element 145 that is not a function of the actual current in thermal element 145.

It will also be appreciated that while thermal element 145 has been described having a temperature coefficient of resistance a, thermal element 145 may also include other material properties, such as electrical resistivity, specific heat, and thermal conductivity for example.

By implementing thermal element 145 as herein disclosed, mechanical calibration of the tripping characteristics of circuit breaker 100 may be no longer required, or at least the re-calibration cycling of circuit breaker 100 would be substantially reduced. To accommodate the use of one thermal element 145 over multiple X-ratings, memory 185 at processing circuit 180 would be programmed to contain a plurality of time-current characteristic curves 300, 310, best seen by referring to FIG. 2, with each curve being associated with a particular X-rating of circuit breaker 100. During the optioning, or option dispensing, of electronic trip unit 155 at a production test station, during the manufacturing process, electronic trip unit 155 would be programmed to have processing circuit 180 recognize and implement a defined trip-time characteristic depending on the defined X-rating of circuit breaker 100. Since option dispensing is an off-line process, and electronic calibration is relatively insensitive to thermal buildup that requires a cool-down cycle, the electronic calibration of circuit breaker 100 having thermal element 145 and electronic trip unit 155, would be substantially faster and less disruptive to a production process flow than would be a thermal calibration process to a circuit breaker implementing a standard bimetal-type thermal trip unit.

Where multiple time-current characteristic curves 300, 310 are stored at memory 185, processing circuit 180 would be programmed according to the X-rating of circuit breaker 100 to associate a calculated value representative of the current in conduction path 115 with at least one of the plurality of time-current characteristic curves 300, 310 before determining whether a trip threshold has been exceeded.

As disclosed, some embodiments of the invention may include some of the following advantages: a trip system that is responsive to electrical current in the long-time, short-time, and instantaneous regions of a time-current curve, including being responsive to a first half-cycle current wave of a short circuit; an electronic trip system that is responsive to a first half-cycle current wave of a short circuit while providing additional functionality through the addition of circuit breaker accessories capable of interfacing with the electronic trip unit; an electronic trip unit having thermal memory; a circuit breaker having field programmable amperage ratings; use of a common bimetal across a broad range of amperages; a substantial reduction or elimination of production time spent on calibration of the bimetal; and, reduced cost by using a bimetal as a low cost current sensor.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. An apparatus for providing electrical protection to a protected circuit in electrical communication with an electrical source, the apparatus comprising:
a housing;
a separable conduction path in series connection with the protected circuit;
an operating mechanism in operable communication with the separable conduction path;
a thermal element in thermal communication with the separable conduction path; and
an electronic trip unit in signal communication with the thermal element and in operable communication with the operating mechanism;
wherein the electronic trip unit is adapted to sense a voltage drop across the thermal element and to trip the operating mechanism in response to the sensed voltage drop being in excess of a first trip threshold.

2. The apparatus of claim 1, wherein the thermal element comprises a resistive element.

3. The apparatus of claim 2, wherein the resistive element comprises a bimetal.

4. The apparatus of claim 3, wherein the thermal element is arranged to mechanically trip the operating mechanism in response to an overcurrent condition in the protected circuit being in excess of a second trip threshold.

5. The apparatus of claim 3, wherein:
the first trip threshold is representative of a first current level; and
the second trip threshold is representative of a second current level that is greater than the first current level.

6. The apparatus of claim 5, further comprising:
a magnetic trip unit in signal communication with the separable conduction path and in operable communication with the operating mechanism;
wherein the magnetic trip unit is arranged to mechanically trip the operating mechanism in response to an overcurrent condition in the protected circuit being in excess of a third trip threshold.

7. The apparatus of claim 6, wherein:
the third trip threshold is representative of a third current level that is greater than the second current level.

8. The apparatus of claim 3, wherein:
the bimetal is adapted to conduct a first steady state electrical current having a first steady state rating and a second steady state electrical current having a second steady state rating, the second steady state rating being two-times the first steady state rating; and
the electronic trip unit is configurable to provide an X-rating of the apparatus equal to the first steady state rating, the second steady state rating, or both steady state ratings.

9. The apparatus of claim 8, wherein:
the bimetal is adapted to conduct a third steady state electrical current having a third steady state rating, the third steady state rating being three-times the first steady state rating; and
the electronic trip unit is configurable to provide an X-rating of the apparatus equal to the third steady state rating.

10. The apparatus of claim 9, wherein:
the bimetal is adapted to conduct a fourth steady state electrical current having a fourth steady state rating, the fourth steady state rating being four-times the first steady state rating; and
the electronic trip unit is configurable to provide an X-rating of the apparatus equal to the fourth steady state rating.

11. The apparatus of claim 1, wherein the first trip threshold is adjustable subsequent to the apparatus being installed in an application.

12. The apparatus of claim 1, wherein the electronic trip unit is adapted to receive electrical power from the line voltage of the electrical source.

13. A method of protecting an electrical circuit in electrical communication with an electrical source, the method comprising:
sensing a voltage drop across a resistive element disposed in a separable conduction path connected in series with the electrical circuit;
in response to the sensed voltage drop, calculating a value representative of the current in the conduction path;
comparing the calculated value to a threshold value; and
in response to the calculated value being in excess of the threshold value, tripping an operating mechanism and separating the separable conduction path.

14. The method of claim 13, wherein the resistive element comprises a bimetal, and further comprising:
determining an ambient temperature;
wherein the calculating a value representative of the current in the conduction path further comprises compensating for that portion of the sensed voltage drop that is a function of the ambient temperature.

15. The method of claim 13, wherein the threshold value is a characteristic curve that is a function of current and time.

16. The method of claim 13, wherein the threshold value is a characteristic curve that is a function of temperature and time.

17. The method of claim 13, wherein the calculated value is a function of the ambient temperature, heat generated by the current in the resistive element, and heat transfer from the conduction path.

18. The method of claim 17, wherein:
the calculated value is a function of the temperature of the resistive element; and
the resistive element comprises a material characteristic comprising an electrical resistivity, a temperature coefficient of resistance, a specific heat, a thermal conductivity, or any combination of material characteristics comprising at least one of the foregoing.

19. The method of claim 13, further comprising:
updating an accumulator with a timed update of the calculated value; and
resetting the accumulator to an initial setting in response to a reset signal.

20. The method of claim 13, further comprising:
associating the calculated value with at least one of a plurality of time-current characteristic curves stored in a memory prior to determining whether a trip threshold has been exceeded.
